(19) United States
(12) Patent Application Publication
(10) Pub. No.: US 2023/0304609 A1
(43) Pub. Date: Sep. 28, 2023

(54) PASS-THROUGH APPARATUS FOR WALL MOUNTED SIGN ASSEMBLY

(71) Applicant: Principal Lighting Group, LLC, SAN ANGLEO, TX (US)

(72) Inventor: J. Bryan Vincent, San Angelo, TX (US)

(21) Appl. No.: 18/190,629

(22) Filed: Mar. 27, 2023

Related U.S. Application Data
(60) Provisional application No. 63/323,852, filed on Mar. 25, 2022.

(51) Int. Cl. F16L 5/02

(52) U.S. Cl. CPC F16L 5/02

(57) ABSTRACT

A disclosed pass-through apparatus suitable for use in a lighting assembly includes a cylindrical conduit and a flexible, self-sealing grommet. The cylindrical conduit has a length suitable for extending from a first position within an inside environment on a first side of a wall, through a hole in a wall to an outside environment. The flexible grommet defines a cylindrical channel extending a length of the grommet, from a first end of the grommet to a second end. The conduit extends through the channel and the grommet is positionable at any of a plurality of positions along the length of the grommet. The grommet defines an annular groove, formed in an outer diameter of the grommet, at the intermediate position. The annular groove is sized to engage an opening in a panel of the lighting assembly located in the outside environment.

### TECHNICAL FIELD

The present disclosure relates to commercial signs and, more specifically, channel letter and other types of signs mounted on or adjacent to an exterior wall.

### BACKGROUND

Exterior lighted signs including, as an example, channel letter signs, are widely used by retailers and other types of business to promote a business, service, or product and to attract and engage potential customers and clients. Exterior lighted signs typically include one or more light sources located within an enclosure that defines the shapes of the sign's letters and other graphic elements. Such signs are frequently attached directly to or in close proximity to a building and, more specifically, an outside surface of an exterior wall of the building, while the source of power required to illuminate the light source(s) is frequently located within the building, i.e., on the other side of the exterior wall. In such configurations, it is generally necessary to provide power to the sign via insulated, electrically conductive wires, referred to herein as supply wires, that pass-through openings in the wall and a wall-adjacent surface or panel of the sign enclosure. As a general rule, the holes through which supply wires pass from the inside of a building to the light source(s) have an unfinished quality that may include sharp and rigid edges capable of damaging insulation that surrounds the supply wire and/or the supply wire itself, particular during installation of the sign. It would therefore be desirable to implement a method and/or apparatus that would permit a supply wire to pass-through the wall and the adjacent surface of the sign enclosure while protecting the supply wire from the wall, the enclosure, and the edges of holes formed therein.

### SUMMARY

In accordance with subject matter disclosed in the following description, disclosed wall-affixed or wall-adjacent lighting assemblies for an outdoor sign, such as a channel letter sign, employ a pass-through apparatus that facilitates toolless coupling of an “inside” power supply to an “outside” wall-affixed or wall-adjacent sign. The pass through apparatus includes a specially configured grommet engaging a length of plastic pipe. The grommet includes an annular groove to engage a rear panel of the sign and, when the assembly is fully installed, the grommet is positioned in contact with the wall. The assembly can easily accommodate variations in wall thickness by positioning the grommet appropriately along the conduit. In addition, the assembly provides inherent, water tight seals that isolate the interior of the sign and the inside environment, where the power supply is located, from the outside environment.

In one aspect, a disclosed pass-through apparatus suitable for use in a lighting assembly includes a cylindrical conduit and a flexible, self-sealing grommet. The cylindrical conduit has a length suitable for extending from a first position within an inside environment on a first side of a wall, through a hole in a wall to an outside environment. The flexible grommet defines a cylindrical channel extending a length of the grommet, from a first end of the grommet to a second end. The conduit extends through the channel and the grommet is positionable at any of a plurality of positions along the length of the grommet. The grommet defines an annular groove, formed in an outer diameter of the grommet, at the intermediate position. The annular groove is sized to engage an opening in a panel of the lighting assembly located in the outside environment.

The grommet may have a substantially circular cross section and an outer diameter of the grommet may increase, linearly or otherwise, from the first end of the grommet to an intermediate point. The outer diameter may decrease in a contiguous curved manner from the intermediate point to the second end wherein the outer diameter and inner diameter may converge at the second end. In contrast, the outer diameter may be appreciably greater than the inner diameter at the first end. The grommet may be comprised of silicon, rubber, a combination of silicon and rubber or another suitable flexible material. A diameter of the annular groove may be approximately 0.01 to 0.05 inches greater than a diameter of the opening in the panel to ensure a good seal when the annular groove engages the sign panel opening. The length of the grommet between the intermediate point and the second end may be substantially equal to a displacement between the second side of the wall and the panel of the sign assembly. A length of the grommet from the first end to the intermediate point may be greater than a length of the grommet from the intermediate point to the second end. When the annular groove engages the hole in the panel, the grommet self-seals an interior of the sign assembly from the outside environment. Similarly, when the second end is in contact with the second surface of the wall, the grommet self-seals the outside environment from the inside environment.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an exemplary lighting assembly;

FIG. 2 illustrates an exemplary pass-through apparatus suitable for use in connection with the lighting assembly illustrated in FIGS. 1; and

FIG. 3 and FIG. 4 illustrate a first and second cross section views of an exemplary grommet suitable for use in the pass-through apparatus of FIG. 2.

Unless indicated otherwise, drawings are not to scale, but may be suggestive of comparative dimensions.

### DETAILED DESCRIPTION

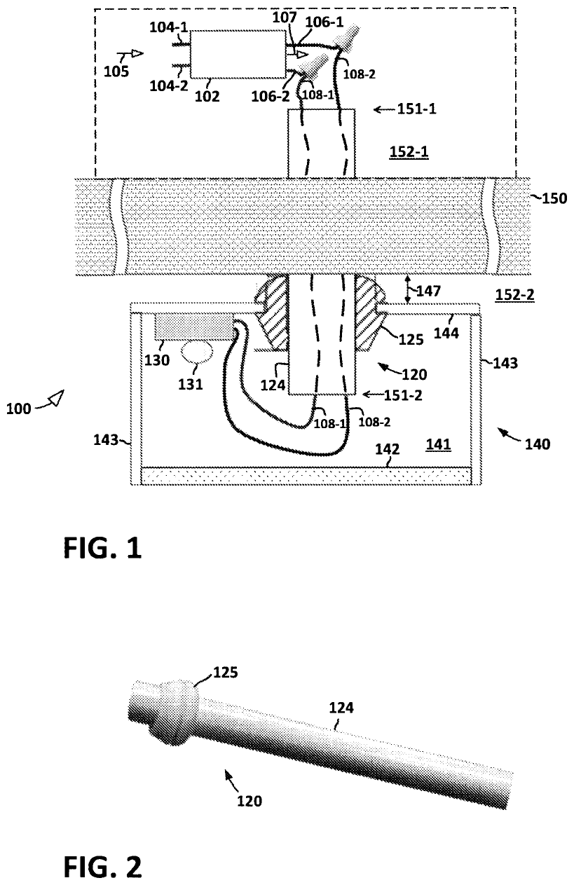

Exemplary embodiments and their advantages are best understood by reference to FIGS. 1-3, wherein like numbers are used to indicate like and corresponding parts unless expressly indicated otherwise.

Referring now to the drawings, FIG. 1 illustrates a wall-affixed or wall-adjacent lighting assembly, referred to herein simply as assembly 100, in which a lighted sign 140 is affixed to, or positioned in close proximity to, a wall 150 that defines a boundary between an inside environment 152-1 and an outside environment 152-2. The assembly 100 depicted in FIG. 1 includes a pass-through apparatus referred to herein simply as pass-through 120 and a sign 140 enclosing a lighting module 130 and a corresponding light source 131. FIG. 2 illustrate a perspective view of an exemplary pass-through 120.

The illustrated assembly 100 is powered by a power supply 102 that is electrically connected to lighting module 130. The depicted power supply 102 includes input terminals 104-1 and 104-2 for receiving an input signal 105 from a power source, and output terminals 106-1 and 106-2, for delivering an AC or DC supply signal 107 to a load such as the lighting module 130. Input signal 105 may be or may be derived from a mains supply (not depicted in FIG. 1), e.g., a 50 or 60 Hz, 120 or 240 V AC signal, or another suitable AC or DC signal. In at least some embodiments, power supply 102 is a low voltage supply wherein supply signal 107 has a maximum voltage of 48 V or less.

The pass-through 120 illustrated in FIG. 1 and FIG. 2 includes a conduit 124 and a grommet 125. Conduit 124 may be a rigid, semi-rigid, or flexible length of a pipe comprised of plastic, metal, or another suitable material or combination of materials. Although the conduit 124 depicted in FIG. 2 has a circular cross section, conduit 124 may have any elliptical, rectangular, or irregularly shaped cross section. In at least one embodiment, conduit 124 is implemented with a polyvinyl chloride (PVC) pipe with an inner diameter of approximately 1.5 inches or less. In other embodiments, a different material may be used and an inner diameter of conduit 124 may be greater than or less than 1.5 inches.

The conduit 124 illustrated in FIG. 1 extends from a first position 151-1, located within an inside environment 152-1 defined by wall 150, through a hole (not visible in FIG. 1) in wall 150 to an outside environment 152-2, and then through a hole (not depicted in FIG. 1) in a rear panel 144 of sign 140 to second position 151-2 within an interior 141 of sign 140. In at least some embodiments, sign 140 is a channel letter sign, or a portion of a channel letter sign, that includes, in addition to the rear panel 144, a translucent front panel 142 and side panels 143.

FIG. 1 illustrates output terminals 106-1 and 106-2 of power supply 102 connected to lighting module 130 via supply wires 108-1 and 108-2 that extend through conduit 124. The depicted lighting module 130 includes a light source 131 and suitable electronics and circuitry to transform electromagnetic energy in output signal 107 to visible light energy. In at least some embodiments, the illustrated light source 131 is or includes one or more light emitting diodes (LEDs).

As depicted in FIG. 1 and FIG. 2, the illustrated pass through 120 includes a grommet 125 that engages conduit 124. Grommet 125 may be comprised of silicon, rubber, or another suitable flexible material or a combination of two or more suitable materials, enabling grommet 125 to be positioned anywhere along the length of conduit 124.

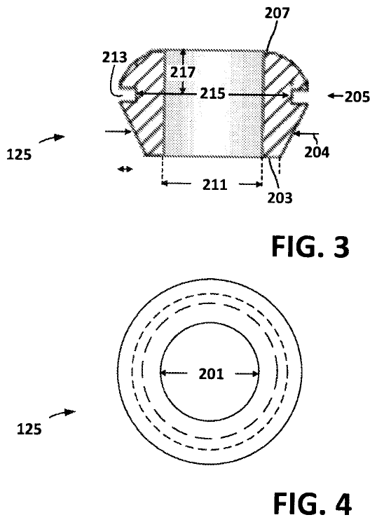

FIG. 3 and FIG. 4 illustrate cross sections of an exemplary grommet 125. The grommet 125 depicted in FIG. 4 has a generally circular cross section forming an inner diameter 201 sized to engage conduit 124 snugly. In at least some embodiments, the grommet inner diameter 201 is slightly less, e.g., 1 to 5 mm less, than an outer diameter 211 of conduit 124. In these embodiments, the flexibility of grommet 125 permits the inner diameter to increase sufficiently to engage conduit 124 and form a water tight seal between grommet 125 and conduit 124. As depicted in FIG. 3, an outer diameter 204 of the illustrated grommet 125 increases linearly from a first end 203 of grommet 125 to an intermediate point 205 and then decreases in a contiguous curved fashion from intermediate point 205 to a second end 207 of grommet, at which point the outer diameter converges with the inner diameter.

The grommet 125 illustrated in FIG. 3 includes or defines an annular groove 213 at the intermediate point 205. In at least some embodiments including embodiments depicted in FIG. 1, annular groove 213 is sized to engage an opening or hole in rear panel 144 of sign 140 when pass-through 120 is installed in the sign assembly 100 of FIG. 1. In at least some embodiments, the hole in rear panel 144 has a diameter that is substantially equal to or slightly less than, e.g., 1 to 5 mm less than, the groove diameter 215 (FIG. 3).

In the configuration illustrated in FIG. 1, an upper dimension 217 of grommet 125 determines a displacement 147 (FIG. 1) between the sign rear panel 144 and wall 150 when assembly 100 is fully installed, with grommet 125 positioned in contact with wall 150 and with the rear panel 144 of sign 140 engaging the annular groove of grommet 125. For embodiments that employ silicon, rubber, or another suitable material for grommet 125, the contact between grommet 125 and wall 150 may form a water tight seal that requires no additional sealant or adhesive. Nevertheless, embodiments may reinforce and stabilize the seal between grommet 125 and wall 150 with a suitable sealant and/or adhesive. Similarly, the illustrated assembly 100 includes a second water tight seal where rear panel 144 engages the annular groove of grommet 125. This second seal may, like the first seal, be reinforced and stabilized with an adhesive and/or sealant.

Thus, the assembly 100 depicted in FIG. 1 can be toollessly installed to couple an “inside” power supply such as the power supply 102 of FIG. 1 to an “outside” wall-affixed or near-wall sign such as the sign 140 of FIG. 1. The assembly 100 can easily accommodate variations in wall thickness by positioning the grommet 125 appropriately along conduit 124. In addition, the assembly 100 provides inherent water tight seals that isolate the inside environment 152-1 and the interior 141 of sign 140 from the outside environment 152-2. Although both of these seals are designed to require no added sealant or adhesive, both seals can easily be reinforced and stabilized with a sealant and/or adhesive.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A pass-through apparatus suitable for use in a lighting assembly, wherein the pass-through apparatus comprises:
a cylindrical conduit of a length suitable for extending from a first position within an inside environment on a first side of a wall, through a hole in a wall to an outside environment;
a flexible grommet defining a cylindrical channel extending a length of the grommet, from a first end of the grommet to a second end of the grommet, wherein the conduit extends through the channel and wherein the grommet is positionable at a plurality of positions along the length of the grommet;
wherein the grommet defines an annular groove formed in an outer diameter of the grommet at the intermediate position, wherein the annular groove is sized to engage an opening in a panel of the lighting assembly.

2. The apparatus of claim 1, wherein the grommet has a substantially circular cross section and wherein an outer diameter of the grommet increases from the first end of the grommet to an intermediate point and wherein the outer diameter decreases from the intermediate point to the second end.

3. The apparatus of claim 2, wherein the outer diameter increases linearly from the first end to the intermediate point.

4. The apparatus of claim 1, wherein the outer diameter decreases in a contiguous curved manner from the intermediate point to the second end.

5. The apparatus of claim 4, wherein the outer diameter and the inner diameter are substantially equal at the second end.

6. The apparatus of claim 1, wherein the grommet is comprises of a flexible material selected from: silicon, rubber, and a combination of silicon and rubber.

7. The apparatus of claim 1, wherein a diameter of the annular groove is approximately 0.01 to 0.05 inches greater than a diameter of the opening in the panel.

8. The apparatus of claim 1, wherein a length of the grommet between the intermediate point and the second end is substantially equal to a displacement between the second side of the wall and the panel of the sign assembly.

9. The apparatus of claim 1, wherein the outer diameter is greater than the inner diameter at the first end.

10. The apparatus of claim 1, wherein a length of the grommet from the first end to the intermediate point is greater than a length of the grommet from the intermediate point to the second end.

11. The apparatus of claim 1, wherein the grommet, when the annular groove engages the hole in the panel, self-seals an interior of the sign assembly from the outside environment.

12. The apparatus of claim 11, wherein the grommet, when the second end is in contact with the second surface of the wall, self-seals the outside environment from the inside environment.
